(19) United States
(12) Patent Application Publication
(10) Pub. No.: US 2015/0381498 A1
(43) Pub. Date: Dec. 31, 2015

(54) NETWORK SYSTEM AND ITS LOAD DISTRIBUTION METHOD

(71) Applicant: HITACHI, LTD., Chiyoda-ku, Tokyo (JP)

(72) Inventors: Kazumasa NOMURA, Tokyo (JP); Yusuke OHASHI, Tokyo (JP); Masaru TODA, Tokyo (JP)

(73) Assignee: HITACHI, LTD., Tokyo (JP)

(21) Appl. No.: 14/769,338

(22) PCT Filed: Nov. 13, 2013
(86) PCT No.: PCT/JP2013/080666

§ 371 Date: Aug. 20, 2015

(51) Int. Cl. H04L 12/803; H04L 12/703; H04L 12/24; H04L 12/707; H04W 24/02

(52) U.S. Cl. CPC H04L 47/125; H04L 45/22; H04W 24/02; H04L 41/0654; H04L 45/28

(57) ABSTRACT

A network system includes a plurality of first computers, which transmit and receive data via a network and are equipped with a plurality of active and standby communication paths. A second computer is connected with the first computers via the network. Each first computer acquires path information concerning active and standby communication paths in the network and traffic of the active communication path and transmits them to the second computer. The second computer: predicts a load on each network node when the communication path is to be switched to each standby communication path; selects a first computer, whose communication path should be switched, and a standby communication path, which is a switching target, based on the prediction result; and requests the first computer to switch the communication path to the standby communication path.

### TECHNICAL FIELD

The present invention relates to a network system and a load distribution method thereof. Particularly, the present invention is suitable to use in a network system including a computer with redundant communication paths.

### BACKGROUND ART

Recently, multiplexing of network nodes such as switching hubs and edge routers which constitute a network has been widely practiced for a network system in order to distribute loads on these network nodes. Multiplexing of the network nodes result in the existence of a plurality of paths in the network; and in case loads on network nodes in a path which is being used become high, the loads on the network nodes can be distributed by using a bypass path.

Multiplexing of the network nodes is a common method of distributing the loads on the network nodes and the loads on the network nodes can be distributed by making redundant of communicating paths by means of redundancy of communication devices such as NICs (Network Interface Cards) for connecting computers, which use the relevant network, to the network on the computer side. With the network system which requires high reliability, a redundant configuration of communication paths equipped with a plurality of active and standby communication devices is often incorporated into the computers in order to enhance fault tolerance.

In order to distribute the loads on the network nodes appropriately in the network system where the network nodes are multiplexed, it is necessary to distribute processing from a heavy-load network node to a low-load network node. For that purpose, it is indispensable to detect the heavy-load network node, so that a system administrator needs to monitor the status of each network node via the network.

SNMP (Simple Network Management Protocol) is generally used as a method for monitoring the status of the network nodes constituting the network. The SNMP is used to mainly detect a critical fault such as a case where a port of a network node physically goes down.

However, in the method of monitoring the network nodes via the network by using the SNMP, only the path which is used for communications with, and is connected with, the active communication device of the computer (hereinafter referred as the “active path”) becomes a target to be monitored among the multiplexed paths; and standby path which are not used for communications with, and is connected with, the standby communication device of the computer (hereinafter referred as the “standby path”) cannot be monitored.

Accordingly, when the communication device used on the computer side is switched to a standby communication device upon detection of a heavy-load on a certain network node (that is, when the communication path is switched from the active path to the standby path), there is a possibility that network performance may further degrade in case the standby path originally has a heavy-load. Specifically speaking, it has been difficult for conventional techniques such as the SNMP monitoring to judge to which standby path would be optimum to switch the communication path; and the SNMP monitoring is rarely used for the purpose of distribution of loads on the network nodes.

Incidentally, examples of the conventional techniques regarding dual paths in a network and monitoring of the network are PTL 1, PTL 2, NPL 1, and NPL 2 mentioned below.

### CITATION LIST

### Patent Literature

[PTL 1] U.S. Unexamined Patent Application Publication No. 2010/0115174

[PTL 2] U.S. Unexamined Patent Application Publication No. 2004/0215821

### Non Patent Literature

[NPL 1] Cisco Systems, [online], “What Is VRRP?” [searched on Oct. 16, 2013], the Internet

<URL:http://www.cisco.com/en/US/products/hw/vpndevc/ps2284/products_tech_note 09186a0080094490.shtml>

[NPL 2] RFC1157, “A Simple Network Management Protocol (SNMP),” [searched on Oct. 16, 2013], the Internet <URL:http://tools.ietf.org/html/rfc1157>

### SUMMARY OF INVENTION

### Technical Problem

The conventional techniques cannot monitor standby path among redundant communication paths in the network as described above. Therefore, in order for the system administrator to check the load status of the standby path, it is necessary to assume the standby path of a business computer based on a network configuration and check the load status of all nodes in the standby path.

However, the network configuration has become complicated due to widespread use of clouds in recent years and there is possibility that the path in use may be changed dynamically. Therefore, under this circumstance, it is difficult for the system administrator to assume the standby path.

The present invention was devised in consideration of the above-described circumstances and aims at suggesting a network system capable of dynamically providing an optimum network environment, in which loads are distributed, without requiring trouble of the system administrator, and a load distribution method for the network system.

### Solution to Problem

In order to solve the above-described problem, provided according to the present invention is a load distribution method for distributing loads on a plurality of network nodes in a network system including a network composed of the plurality of network nodes, a plurality of first computers for transmitting and receiving data via the network, and a second computer connected to the first computers via the network, wherein the first computers include an active communication device for performing communications via the network and at least one standby communication device and the active communication device and the standby communication device are connected to different network nodes, respectively, in the network, wherein the network system load distribution method includes: a first step executed by the first computer acquiring path information concerning an active communication path and a standby communication path in the network and traffic of the active communication path; a second step executed by the first computer transmitting the acquired path information concerning the active communication path and the standby communication path and the traffic of the active communication path, respectively, to the second computer; a third step executed by the second computer searching for a network node with a heavy-load among the respective network nodes constituting the network based on the path information concerning the active communication path and the standby communication path and the traffic of the active communication path which are transmitted from the first computer; and a fourth step executed, upon detecting the network node with the heavy-load, by the second computer: predicting a load on each of the network nodes when the communication path of each first computer is to be switched to its individual standby communication path; selecting the first computer, whose communication path should be switched from the active communication path to the standby communication path, based on a result of the prediction and the standby communication path which should be a switching target of the communication path for the first computer; and requesting the selected first computer to switch the communication path from the active communication path to the selected standby communication path.

Furthermore, provided according to the present invention is a network system including: a network composed of a plurality of network nodes; a plurality of first computers for transmitting and receiving data via the network; and a second computer connected to the first computers via the network; wherein the first computers includes an active communication device for performing communications via the network and at least one standby communication device and the active communication device and the standby communication device are connected to different network nodes, respectively, in the network; wherein the first computer: acquires path information concerning an active communication path and a standby communication path in the network and traffic of the active communication path; and transmits the acquired path information concerning the active communication path and the standby communication path and the traffic of the active communication path, respectively, to the second computer; and wherein the second computer searches for a network node with a heavy-load among the respective network nodes constituting the network based on the path information concerning the active communication path and the standby communication path and the traffic of the active communication path which are transmitted from the first computer; and upon detecting the network node with the heavy-load, the second computer: predicts a load on each of the network nodes when the communication path of each first computer is to be switched to its individual standby communication path; selects the first computer, whose communication path should be switched from the active communication path to the standby communication path, based on a result of the prediction and the standby communication path which should be a switching target of the communication path for the first computer; and requests the selected first computer to switch the communication path from the active communication path to the selected standby communication path.

### Advantageous Effects of Invention

A network system capable of dynamically providing an optimum network environment, in which loads are distributed, without requiring trouble of a system administrator, and a load distribution method for the network system can be provided according to the present invention.

### BRIEF DESCRIPTION OF DRAWINGS

[FIG. 1]

FIG. 1 is a block diagram illustrating an overall configuration of a network system according to this embodiment;

[FIG. 2]

FIG. 2 is a block diagram illustrating a schematic configuration of a business computer;

[FIG. 3]

FIG. 3 is a block diagram illustrating a schematic configuration of a supervisory computer;

[FIG. 4]

FIG. 4 is a conceptual diagram illustrating a schematic configuration of a communication information management database retained by the business computer;

[FIG. 5]

FIG. 5 is a conceptual diagram illustrating a schematic configuration of a communication information management database retained by the supervisory computer;

[FIG. 6]

FIG. 6 is a conceptual diagram illustrating a schematic configuration of a communication information database;

[FIG. 7]

FIG. 7 is a conceptual diagram for explaining statistic information;

[FIG. 8]

FIG. 8 is a flowchart illustrating a flow of business-computer-side processing and supervisory-computer-side processing.

[FIG. 9]

FIG. 9 is a flowchart illustrating a procedure of monitored packet transmission processing;

[FIG. 10]

FIG. 10 is a flowchart illustrating a procedure of monitored packet reception processing;

[FIG. 11]

FIG. 11 is a flowchart illustrating a procedure of heavy-load node search processing;

[FIG. 12]

FIG. 12 is a flowchart illustrating a procedure of path switching computer selection processing; and

[FIG. 13]

FIG. 13 is a block diagram illustrating an overall configuration of a network system according to another embodiment.

### DESCRIPTION OF EMBODIMENTS

An embodiment of the present invention will be explained below in detail with reference to drawings.

(1) Configuration of Network System According to this Embodiment

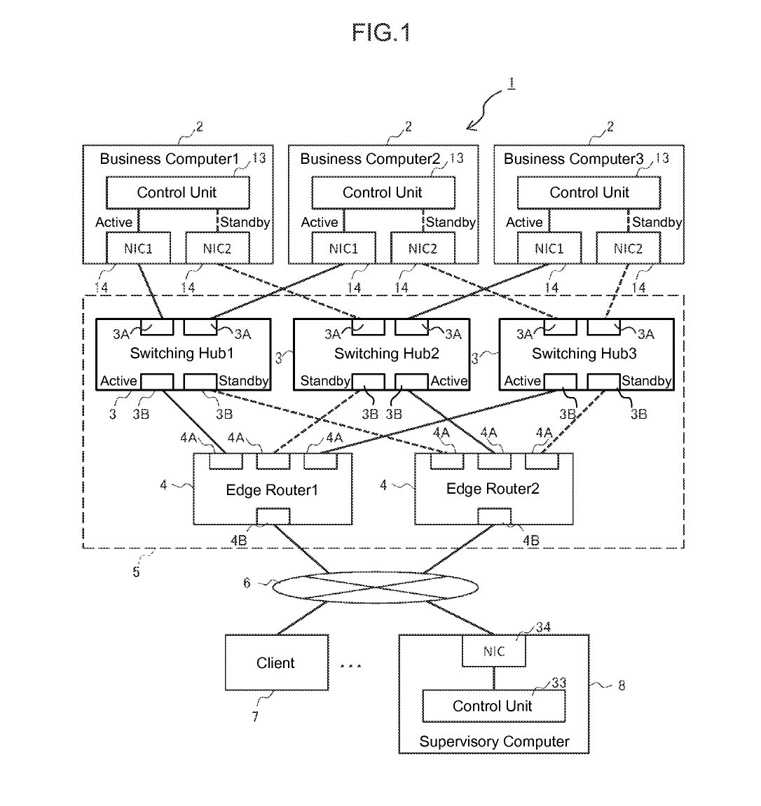

Referring to FIG. 1, reference numeral 1 represents a network system according to this embodiment as a whole. This network system 1 is configured so that a plurality of business computers 2 are connected with a client 7 via an internal network 5, which is configured of a plurality of switching hubs 3 and a plurality of edge routers 4, and an external network 6 to allow free communications between the business computers 2 and the client 7; and a supervisory computer 8 is connected to the external network 6.

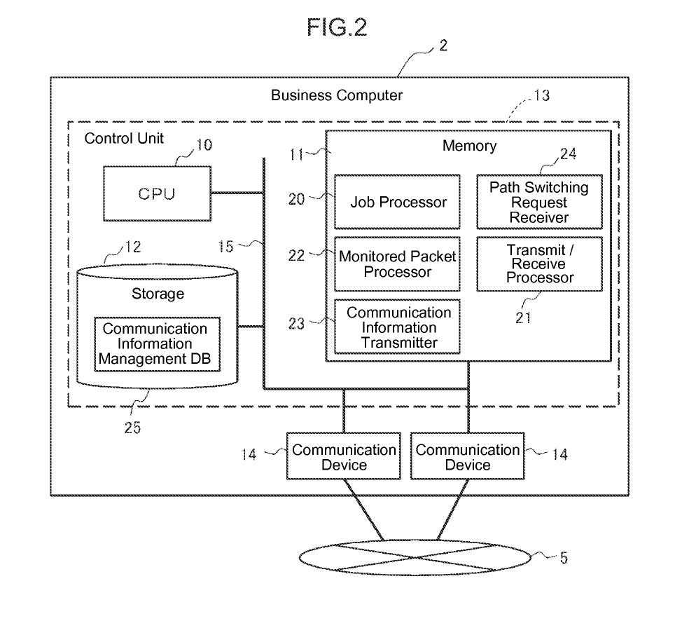

The business computer 2: is a server system that provides specified services to the client 7; includes, as illustrated in FIG. 2, a control unit 13 equipped with a CPU (Central Processing Unit) 10, a memory 11, and storage 12, and communication devices 14; and is configured so that the CPU 10, the memory 11, the storage 12, and the communication devices 14 are connected via an internal bus 15.

The CPU 10 is a processor that controls the operation of the entire business computer 2. Also, the memory 11 is composed of, for example, a volatile semiconductor memory and is mainly used as a work memory for the CPU 10. The memory 11 stores: a job processor 20 that is a program for executing various processing with respect to services provided by the business computer 2; and a transmit/receive processor 21 that is a program for executing processing for transmitting and receiving packets via the communication devices 14. A monitored packet processor 22, a communication information transmitter 23, and a path switching request receiver 24 which will be described later are also stored and retained in this memory 11.

The storage 12 is a mass storage system and is composed of, for example, hard disk drives. The above-mentioned job processor 20, transmit/receive processor 21, monitored packet processor 22, communication information transmitter 23, and path switching request receiver 24 are read from the storage 12 at the time of, for example, activation of the business computer 2 and are stored in the memory 11. This storage 12 stores and retains a communication information management database 25 described later.

The communication device 14 is composed of, for example, an NIC (Network Interface Card) and performs protocol control upon communications with the client 7 (FIG. 1) or the supervisory computer 8 (FIG. 1) via the internal network 5. In this embodiment, the communication device 14 is made redundant in the business computer 2; and one of the plurality of communication devices 14 is used as an “active” communication device for normal communications and the rest of the communication devices 14 are used as “standby” communication devices when the communications cannot be performed via the active communication device 14 or in order to distribute loads on the network nodes in the internal network 5. Therefore, in this embodiment, the active and standby communication devices 14 are connected to different switching hubs 3, respectively, as illustrated in FIG. 1. Incidentally, referring to FIG. 1, the communication device 14 is indicated as “NIC”; however, a communication device other than the NIC can be applied as the communication device 14. The same applies hereinafter.

The switching hubs 3 are repeaters which constitute part of the internal network 5. The switching hub 3 is configured by including a plurality of business-computer-side ports 3A and a plurality of edge-router-side ports 3B and the respective business-computer-side ports 3A are connected to different business computers 2 and the respective edge-router-side ports 3B are connected to different edge routers 4.

Some edge-router-side ports 3B of the switching hub 3 are set as active ports and the rest of the edge-router-side ports 3B are set as standby ports. Then, the switching hub 3 normally executes relay processing through the active path routed through the active edge-router-side port 3B; and meanwhile, for example, in response to a command from the business computer 2, the switching hub 3 switches the port in use from the active edge-router-side port 3B to the standby edge-router-side port 3B and executes relay processing through the standby path routed through the standby edge-router-side port 3B.

The edge routers 4 constitute part of the internal network 5 and are repeaters for connecting the internal network 5 and the external network 6. The edge router 4 is configured by including a plurality of switching-hub-side ports 4A and at least one external-network-side port 4B; and the respective switching-hub-side ports 4A are connected to the edge-router-side ports 3B of different switching hubs 3 and the external-network-side port 4B is connected to the external network 6.

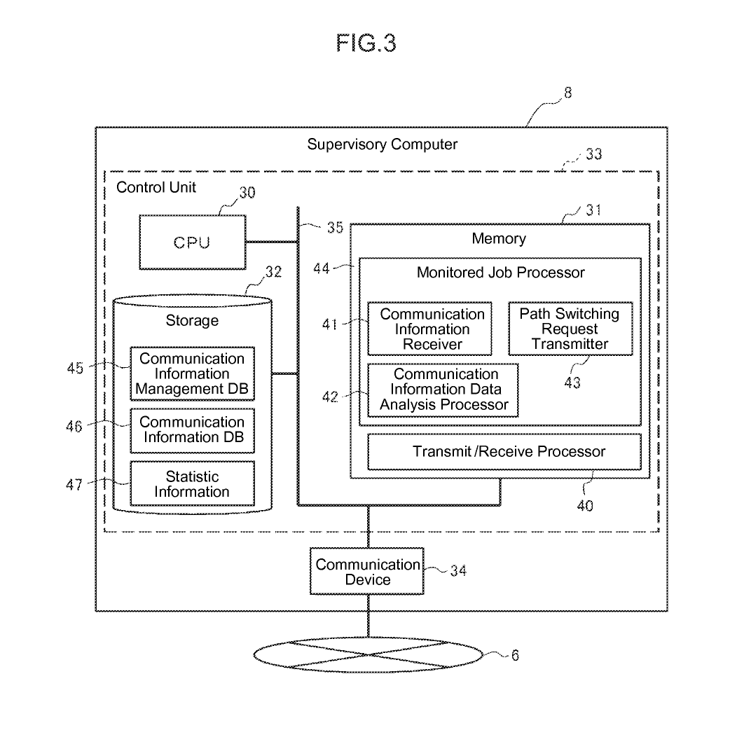

The supervisory computer 8 is a computer having a function that: monitors loads on the respective network nodes (the switching hubs 3 and the edge routers 4) constituting the internal network 5 as described later; and requests a business computer, which uses a network node with a heavy-load, to switch the communication path to the standby path when it detects that network node. This supervisory computer 8 includes, as illustrated in FIG. 3, a control unit 33 equipped with a CPU 30, a memory 31, and storage 32, and a communication device 34; and is configured so that the CPU 30, the memory 31, the storage 32, and the communication device 34 are connected via an internal bus 35.

The CPU 30 is a processor that controls the operation of the entire supervisory computer 8. Also, the memory 31 is composed of, for example, a volatile semiconductor memory and is mainly used as a work memory for the CPU 30. The memory 31 stores a transmit/receive processor 40 that is a program for executing processing for transmitting and receiving packets via the communication devices 14. A monitored job processor 44 equipped with a communication information receiver 41, communication information data analysis processor 42, and path switching request transmitter 43 described later is also stored and retained in this memory 31.

The storage 32 is a mass storage system and is composed of, for example, hard disk drives. The above-mentioned transmit/receive processor 40, communication information receiver 41, communication information data analysis processor 42, and path switching request transmitter 43 are read from the storage 32 at the time of, for example, activation of the supervisory computer 8. This storage 32 stores and retains a communication information management database 45, a communication information database 46, and statistic information 47 which will be described later.

The communication device 34 is composed of, for example, an NIC and performs protocol control during communications with the business computer 2 (FIG. 2) via the external network 6.

The client 7 is a computer device used by a user who uses services provided by the business computer 2. The client 7 requests provision of necessary information from the business computer 2 via the external network 6 and the internal network 5 and the business computer 2 transmits the requested information to the client 7 via the internal network 5 and the external network 6.

(2) Network Load Distribution Method according to Present Embodiment

Next, a network load distribution method adopted by this network system 1 will be explained.

In the case of this network system 1, each business computer 2 regularly transmits a packet for monitoring (hereinafter referred as the monitored packet) to all the active path and standby path respectively via the active communication device 14 and the standby communication device 14. Under this circumstance, the monitored packet which is transmitted by the business computer 2 to the active path and the standby path is not a simple ICMP (Internet Control Message Protocol) packet used for ping, but a packet for acquiring path information in order to detect, for example, network nodes (the switching hubs 3 and the edge routers 4) through which the active path and the standby path are routed. Therefore, each network node which receives this monitored packet sequentially writes, for example, its own identification information and reception time to the monitored packet and transmits it to a network node of the next stage; on the other hand, when a node which is a destination of this monitored packet receives the monitored packet, it returns the monitored packet to the business computer 2 which is a transmitter.

Then, the business computer 2 saves, as communication path information in the storage 12 (FIG. 2), the path information acquired concerning the active path and the standby path by using the monitored packet (information concerning the network nodes along the active path or the standby path and the external network 6 and their order) and response time (time it takes to receive the monitored packet returned after transmitting it to the active path or the standby path), and traffic per unit time (for example 1 second) when the active path is used; and the business computer 2 also regularly transmits the communication path information, which is saved in the storage 12, to the supervisory computer 8.

The supervisory computer 8 collects and saves the communication path information, which is transmitted regularly from each business computer 2 as described above, in the storage 32 (FIG. 3). Furthermore, the supervisory computer 8 judges a load status of each of the network nodes constituting the internal network 5 based on the communication path information saved in the storage 32; and when the supervisory computer 8 determines that a network node with a heavy-load exists, it selects a business computer 2 whose communication path should be switched, among business computers 2 using that network node and a standby path which should be a switching target. Then, the supervisory computer 8 transmits a request to the thus-selected business computer to switch the communication path from the active path to the standby path selected as described above (hereinafter referred as the “path switching request”).

In this case, when selecting the business computer 2, whose communication path should be switched, and the standby path which should be the switching target, the supervisory computer 8 selects the business computer 2 and the standby path by comprehensively judging the load status of the entire internal network 5. Specifically speaking, the supervisory computer 8 predicts the load on each network node when the communication path is to be switched from the active path to a standby path regarding each candidate business computer 2 (that is, the business computer 2 which uses a heavy-load network node as its active path); and the supervisory computer 8 selects the business computer 2, whose communication path should be switched, and the standby path, which should be the switching target, so that the load on each network node of the switch replacement standby path will not be high when the communication path is switched.

As means for implementing the above-described network load distribution method according to this embodiment, the memory 11 for the business computer 2 stores the monitored packet processor 22, the communication information transmitter 23, and the path switching request receiver 24 and the storage 12 for the relevant business computer 2 stores the communication information management database 25 as described earlier with reference to FIG. 2.

The monitored packet processor 22 is a program having a function that collects, for example, the path information concerning the active path and the standby path of the relevant business computer 2. The monitored packet processor 22 regularly transmits a monitored packet to all the active path and standby path via each of the active and standby communication devices 14, thereby collecting the path information concerning these active path and standby path and response time concerning these active path and standby path. Furthermore, the monitored packet processor 22 refers to a communication log retained by the OS (Operating System) and acquires the traffic per unit time (for example, 1 second) when using the active paths. Then, the monitored packet processor 22 registers these collected pieces of information in the communication information management database 25 stored in the storage 12.

Furthermore, the communication information transmitter 23 is a program having a function that regularly reads the communication path information, which is registered in the communication information management database 25, concerning the active path and the standby path and transmits it to the supervisory computer 8. Furthermore, the path switching request receiver 24 is a program having a function that switches the communication path from the active path to the standby path in response to a request from the supervisory computer 8. Practically, when the business computer 2 receives the path switching request transmitted from the supervisory computer 8, the path switching request receiver 24 controls the transmit/receive processor 21 so that the communication device 14 used for communications will be switched from the active communication device 14 to the communication device 14 corresponding to the standby path designated by the path switching request.

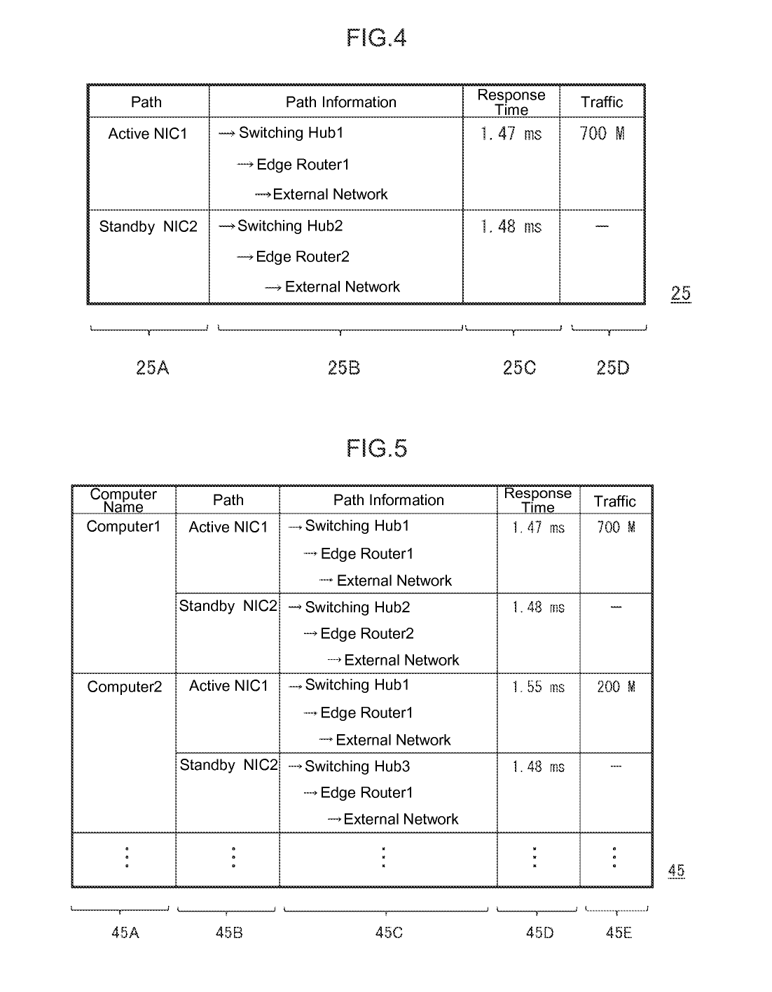

The communication information management database 25 is a database for accumulating the communication path information, which is collected by the monitored packet processor 22, concerning the active path and the standby path. This communication information management database 25 is configured in a table format including a path column 25A, a path information column 25B, a response time column 25C, and a traffic column 25D as illustrated in FIG. 4.

Then, the path column 25A stores identification information of the communication device 14 connected to the corresponding path and information indicating whether that communication device 14 is the active device or the standby device; and the path information column 25B stores path information (information indicating network nodes, through which the communication path is routed, and the order of the network nodes) concerning the communication path connected to that communication device 14. Furthermore, the response time column 25C stores the response time required when acquiring that path information; and the traffic column 25D stores the traffic (however, only the traffic of the active path) of the relevant communication path when acquiring that path information.

Therefore, in the case of FIG. 4, it is shown that the relevant business computer 2 includes, as communication paths, a communication path connected to the “active” communication device 14 which is called “NIC1” and a communication path connected to the “standby” communication device 14 which is called “NIC2”; and the communication path connected to “NIC1” is a path that passes through “Switching Hub 1” and “Edge Router 1” in this order and is then connected to the “external network” and the response time of that communication path is “1.47 ms” and the traffic is “700 Mbyt.”

Furthermore, as described earlier with reference to FIG. 3, the memory 31 for the supervisory computer 8 stores the monitored job processor 44 including the communication information receiver 41, the communication information data analysis processor 42, and the path switching request transmitter 43 and the storage 32 for the relevant supervisory computer 8 stores the communication information management database 45, the communication information database 46, and the statistic information 47.

The communication information receiver 41 is a program having a function that receives the communication path information, which is transmitted regularly from each business computer 2 as mentioned above, concerning the active path and the standby path and registers the received path information in the communication information management database 45.

Furthermore, the communication information data analysis processor 42 is a program having a function that detects a network node with a heavy-load in the internal network 5 based on the communication information management database 45. When the communication information data analysis processor 42 detects the heavy-load network node, it selects a business computer 2, whose communication path should be switched, and a standby path which should be a switching target.

Furthermore, the path switching request transmitter 43 is a program having a function that transmits the aforementioned path switching request to the business computer 2 selected by the communication information data analysis processor 42.

The communication information management database 45 is a database for gathering and accumulating the communication path information, which is transmitted from each business computer 2, concerning the active path and the standby path of the business computer 2. This communication information management database 45 is configured in a table format including a computer name column 45A, a path column 45B, a path information column 45C, a response time column 45D, and a traffic column 45E as illustrated in FIG. 5.

Then, the computer name column 45A stores the name of the relevant business computer 2. Furthermore, the path column 45B, the path information column 45C, the response time column 45D, and the traffic column 45E store the same information as the information stored in the corresponding path column 25A, path information column 25B, response time column 25C, and traffic column 25D of the communication information management database 25 as described above with reference to FIG. 4, respectively, based on the communication path information, which has been transmitted from the relevant business computer 2, concerning the active path and the standby path of that business computer 2.

Therefore, in the case of FIG. 5, it is shown that: business computers 2 whose names are “Computer 1,” “Computer 2,” and so on exist in this network system 1; and for example, the business computer 2 called “Computer 1” includes, as the communication paths, the communication path connected to the “active” communication device 14 called “NIC1” (FIG. 2) and the communication path connected to the “standby” communication device 14 called “NIC2” and the communication path connected to “NIC1” is a path that passes through “Switching Hub 1” and “Edge Router 1” in this order and is then connected to the “external network” and the response time of that communication path is “1.47 ms” and the traffic is “700 Mbyt.”

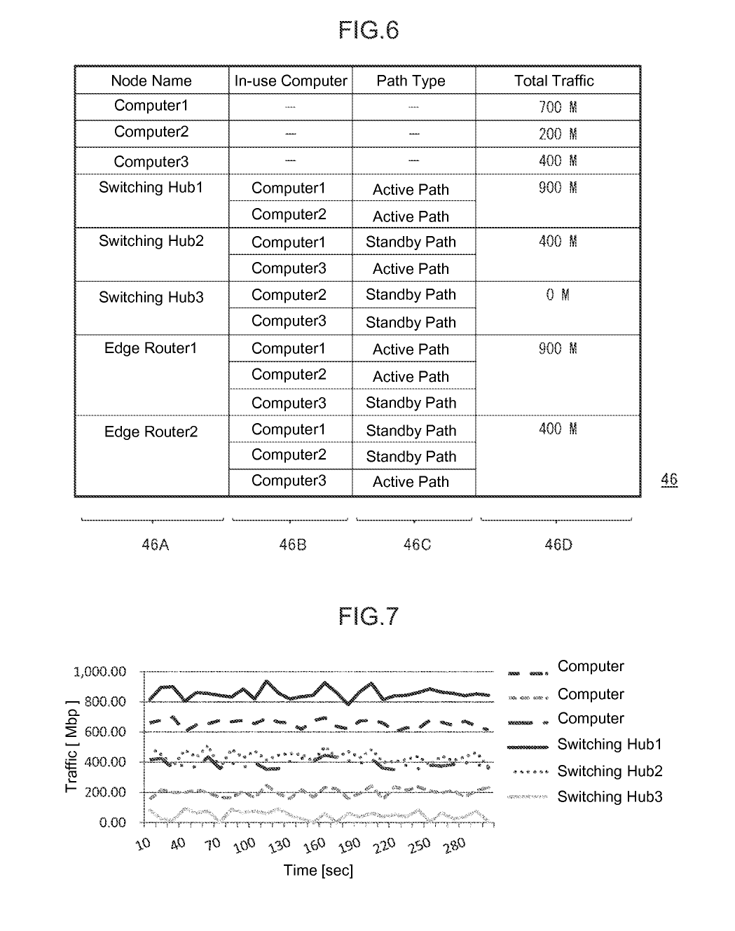

The communication information database 46 is a database temporarily created based on the communication information management database 45 and is used when selecting the business computer 2 whose communication path should be switched. This communication information database 46 is configured in a table format including a node name column 46A, an in-use computer column 46B, a path type column 46C, and a total traffic column 46D as illustrated in FIG. 6.

Then, the node name column 46A stores the node name of each node (the business computers 2, the switching hubs 3, and the edge routers 4) existing in this network system 1; and the in-use computer column 46B stores identification information (computer name) of a business computer 2 whose node is used as an active path or a standby path when the relevant node is a network node. Furthermore, the path type column 46C stores the type of a communication path (whether the active path or the standby path) through which the relevant business computer 2 uses that network node; and the total traffic column 46D stores the total traffic per unit time (for example, 1 second) at the relevant node.

Therefore, in the case of FIG. 6, it is shown that for example, “Switching Hub 2” is used as a “standby path” for the business computer 2 called “Computer 1” and as an “active path” for the business computer 2 called “Computer 3” and the total traffic per unit time at “Switching Hub 2” is “400 M.”

Furthermore, the statistic information 47 is information collected concerning the traffic of each node for each certain amount of time (for example, 10 seconds) for a certain period of time (for example, for several minutes), for example, as illustrated in FIG. 7. FIG. 7 shows the statistic information as a graph for easy understanding, but actually these pieces of information are managed, for example, in a table. Incidentally, FIG. 7 does not show information concerning “Switching Hub 3,” “Edge Router 1,” and “Edge Router 2” in order to avoid complication of the graph.

(3) Various Processing regarding Network Load Distribution Method according to this Embodiment

Next, processing content of various processing executed by the business computer 2 and the supervisory computer 8 in relation to the network load distribution method according to this embodiment will be explained. Incidentally, a processing subject of the various processing will be explained as the “business computer,” the “supervisory computer,” or a “program ( . . . unit)” in the following description; however, it is a matter of course that practically, the relevant program or the CPU 10 (FIG. 2) for the business computer 2 or the CPU 30 (FIG. 3) for the supervisory computer 8 according to the program executes the relevant processing.

(3-1) Flow of Network Load Distribution Processing by this Network Load Distribution Method

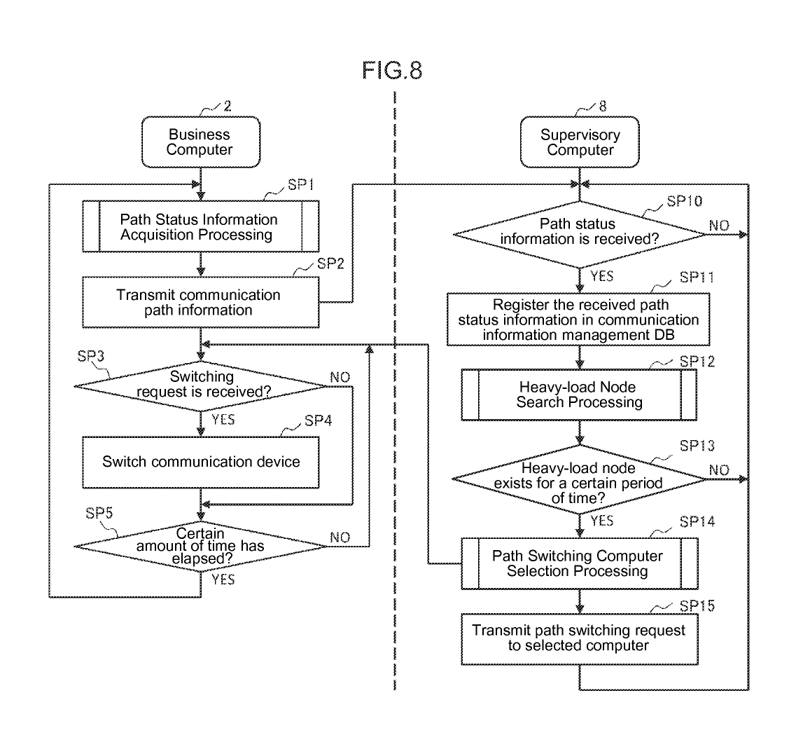

FIG. 8 illustrates a processing flow of business-computer-side processing executed by the business computer 2 (a flowchart on the left side of FIG. 8) and supervisory-computer-side processing executed by the supervisory computer 8 (a flowchart on the right side of FIG. 8) in relation to the network load distribution method according to this embodiment.

For example, when the business computer 2 is powered on, it starts the business-computer-side processing illustrated on the left side of this FIG. 8 and firstly transmits a monitored packet to the active path and the standby path via each of the active-side and the standby-side communication devices 14 (FIG. 2), thereby acquires the path information and the response time concerning the active path and the standby path and also acquires the traffic per unit time concerning the active path from the OS, and registers these pieces of information as the communication path information in the communication information management database 25 (FIG. 4) (SP1). The processing of this step SP1 is executed by the monitored packet processor 22 (FIG. 2) and the transmit/receive processor 21 (FIG. 2).

Subsequently, the business computer 2 transmits the communication path information acquired as described above concerning the individual active path and standby path to the supervisory computer 8 (SP2). Practically, this processing is executed by the communication information transmitter 23 (FIG. 2); and the communication information transmitter 23 reads the communication path information registered in the communication information management database 25 and transmits it to the supervisory computer 8.

Subsequently, the business computer 2 waits for a certain period of time (that is, when the time comes to acquire the next communication path information) to elapse after transmission of the path switching request from the supervisory computer 8 as described later or after start of the processing of step SP1 (SP3-SP5-SP3).

Then, when the business computer 2 receives the path switching request from the supervisory computer 8 before the elapse of the certain period of time after the start of the processing of step SP1 (SP3: YES), it switches the communication path to the designated standby path according to this path switching request (SP4). Practically, this processing is executed by the path switching request receiver 24 (FIG. 2) and the path switching request receiver 24 switches the active communication device 14 in the transmit/receive processor 21 to the standby communication device 14 designated by the path switching request. Consequently, the active and standby communication devices 14 which are set by the transmit/receive processor 21 are switched.

Then, when the certain period of time has eventually elapsed after the start of the processing of step SP1 (SP5: YES), the business computer 2 returns to step SP1 and then repeats the processing of step SP1 and subsequent steps. As a result, the business computer 2 regularly executes the processing from step SP1 to step SP5.

On the other hand, for example, when the supervisory computer 8 is powered on, it starts the supervisory-computer-side processing on the right side of this FIG. 8 and waits for the transmit/receive processor 40 (FIG. 3) to receive the communication path information from the business computer 2 (SP10). Then, when the transmit/receive processor 40 receives the communication path information, the supervisory computer 8 registers this communication path information in the communication information management database 45 (FIG. 5) (SP11). The registration of this communication path information in the communication information management database 45 is executed by the communication information receiver 41 (FIG. 3).

Subsequently, the supervisory computer 8 executes heavy-load node detection processing for detecting a node whose load continues to be high for a certain period of time, by using the communication information management database 45 (SP12). This heavy-load node detection processing is executed by the communication information data analysis processor 42 (FIG. 3) as described later.

Then, in case the supervisory computer 8 fails to detect the network node, whose load continues to be high for the certain period of time, by this heavy-load node detection processing (SP13: NO), it returns to step SP10. On the other hand, in case the supervisory computer 8 successively detects the network node, whose load continues to be high for the certain period of time, by this heavy-load node detection processing (SP13: YES), it executes path switching computer selection processing for selecting a business computer 2, whose communication path should be switched to a standby path, among business computers 2 which use the relevant network node along the active path (SP14). This processing is also executed by the communication information data analysis processor 42 as described later.

Subsequently, the supervisory computer 8 sends a path switching request to the business computer 2 selected by the path switching computer selection processing to switch the communication path from the active path to the standby path (SP15). Transmission of this path switching request is executed by the path switching request transmitter 43 (FIG. 3).

Then, the supervisory computer 8 returns to step SP10 and then repeats the processing of step SP10 and subsequent steps. As a result, every time the supervisory computer 8 receives the communication path information from the business computer 2, it repeats the processing from step SP10 to step SP15.

### (3-2) Path Status Information Acquisition Processing

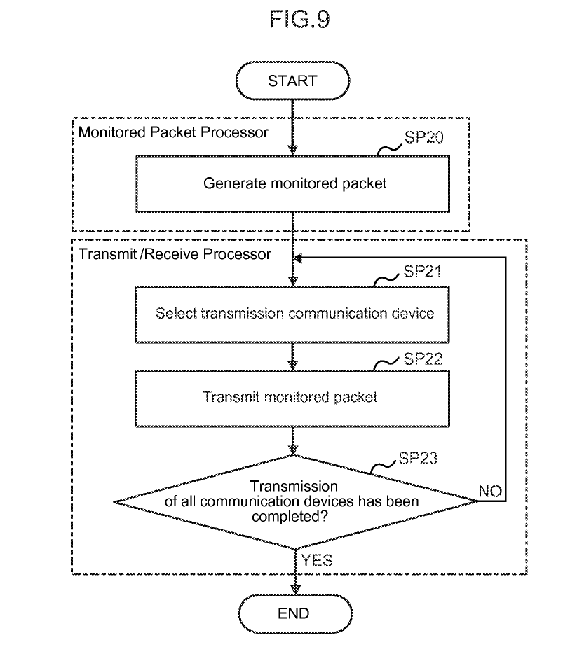

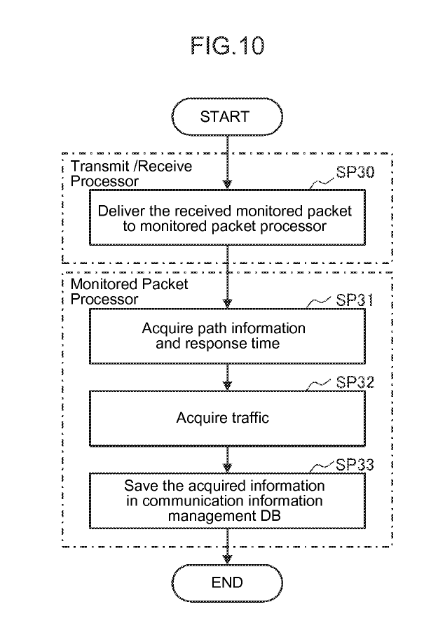

The communication path information acquisition processing described above with respect to step SP1 in FIG. 8 is configured of monitored packet transmission processing (FIG. 9) for transmitting the monitored packet from each communication device 14 for the business computer 2 to the active path and the standby path and monitored packet reception processing (FIG. 10) for acquiring, for example, the path information from the returned monitored packet.

Regarding the monitored packet transmission processing in FIG. 9, the monitored packet processor 22 (FIG. 2) firstly generates a monitored packet. For example, the supervisory computer 8 can be set as a destination of this monitored packet. Then, the monitored packet processor 22 delivers the generated monitored packet to the transmit/receive processor 21 (SP20).

After receiving the monitored packet from the monitored packet processor 22, the transmit/receive processor 21 selects one communication device 14, which has not transmitted the monitored packet yet, among the communication devices 14 of the relevant business computer 2 (SP21) and transmits the monitored packet via that communication device 14 to the internal network 5 (SP22).

Subsequently, the transmit/receive processor 21 judges whether the transmission of the monitored packet via all the communication devices 14 of that business computer 2 has been completed or not (SP23). Then, in case the transmit/receive processor 21 obtains a negative result in this judgment, it returns to step SP21 and then repeats the processing from step SP21 to step SP23 while switching the communication device 14 to be selected thereafter in step SP21 to another unprocessed communication device 14.

Then, in case the transmit/receive processor 21 obtains an affirmative result in step SP23 by eventually finishing transmitting the monitored packet via all the communication devices 14 of that business computer 2 (that is, by finishing transmitting the monitored packet to all the active path and the standby path), it terminates this monitored packet transmission processing.

On the other hand, when the transmit/receive processor 21 receives the monitored packet returned from the supervisory computer 8, the monitored packet reception processing in FIG. 10 is started; and the transmit/receive processor 21 firstly delivers the received monitored packet to the monitored packet processor 22 (SP30).

Then, after receiving the monitored packet, the monitored packet processor 22 acquires the path information from the monitored packet and also acquires time it takes for the monitored packet to return after transmission of that monitored packet, as the response time (SP31). Furthermore, the monitored packet processor 22 acquires the traffic of the communication path, through which that monitored packet was transmitted and received, from the OS (SP32). However, in case the communication path through which the monitored packet was transmitted and received is not the active path, the traffic of that communication path is “0.”

Then, the monitored packet processor 22 stores the path information and response time acquired in step SP31 and the traffic acquired in step SP32 in the communication information management database 25 (FIG. 2) (SP33) and then terminates this monitored packet reception processing.

### (3-3) Heavy-Load Node Search Processing

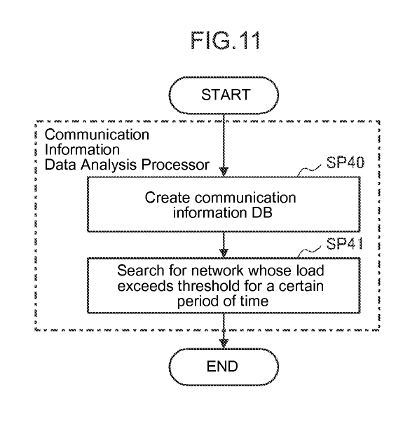

FIG. 11 illustrates specific processing content of heavy-load node detection processing executed by the communication information data analysis processor 42 (FIG. 3) in step SP12 of the supervisory-computer-side processing described earlier with reference to FIG. 8.

After starting this heavy-load node detection processing, the communication information data analysis processor 42 firstly creates the communication information database 46, which was described earlier with reference to FIG. 6, based on the communication information management database 45 (SP40) and then searches for a network node, whose load continues to exceed a threshold for a certain period of time, based on the created communication information database 46 and the statistic information 47 described earlier with reference to FIG. 7 (SP41).

Incidentally, the “threshold” in step SP41 is a value that is set by the system administrator based on an allowable load range of the entire network system 1. A method of deciding the allowable load range of the network system 1 should be decided according to the SLA (Service Level Agreement) or the QoS (Quality of Service). For example, in case “communications that exceed 95% of the allowable traffic of a certain network node occur a specified number of times or more in one minute,” the threshold is set so that the load on the relevant network node will be judged to be high.

Then, when the communication information data analysis processor 42 completes the search processing in step SP41, it terminates this heavy-load node search processing.

### (3-4) Path Switching Computer Selection Processing

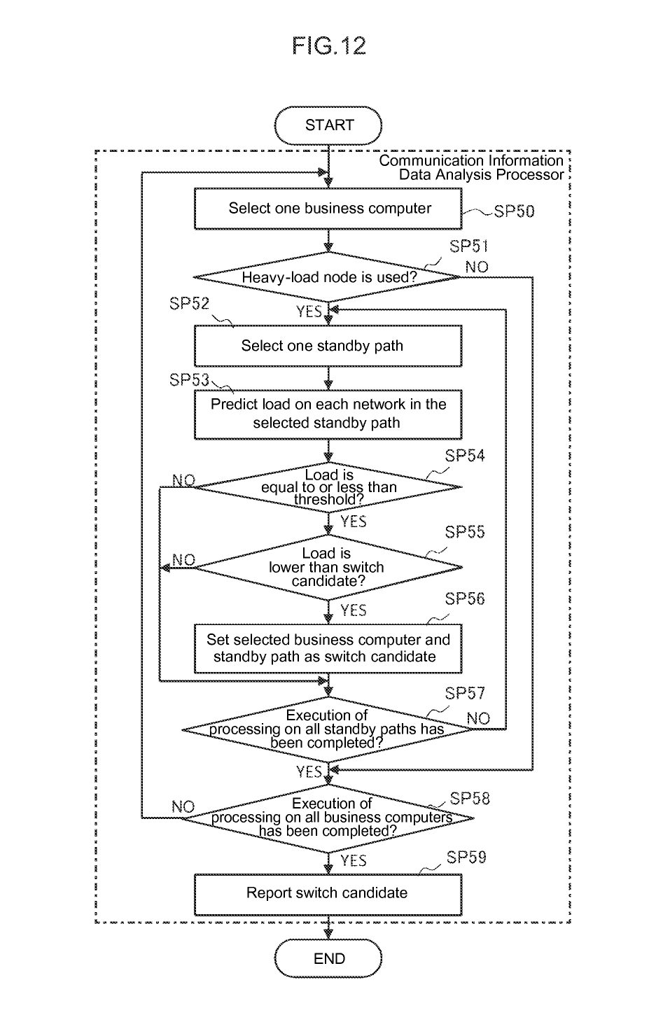

FIG. 12 illustrates specific processing content of the path switching computer selection processing executed by the communication information data analysis processor 42 (FIG. 3) in step SP14 of FIG. 8.

After starting this path switching computer selection processing, the communication information data analysis processor 42 firstly selects one business computer 2 in the system (SP50). Subsequently, the communication information data analysis processor 42 refers to the communication information management database 45 (FIG. 5) and judges whether the business computer 2 selected in step SP50 uses the heavy-load node detected by the above-described heavy-load node search processing (FIG. 11) along the active path or not (SP51).

Under this circumstance, for example, in case the business computer 2 selected in step SP50 is “Computer 3” and the heavy-load node detected by the heavy-load node search processing is “Switching Hub 1” in the example illustrated in FIG. 5 and FIG. 6, it is shown with reference to the communication information management database 45 in FIG. 5 that “Computer 3” is not using “Switching Hub 1” as the active path. Therefore, in this case (SP51: NO), the communication information data analysis processor 42 proceeds to step SP58.

On the other hand, in case the business computer 2 selected in step SP50 is “Computer 2” and the heavy-load node detected by the heavy-load node search processing is “Switching Hub 1”, it is shown with reference to the communication information management database 45 that “Computer 2” is using “Switching Hub 1” as the active path. Therefore, in this case (SP51: YES), the communication information data analysis processor 42 refers to the communication information management database 45 and selects one standby path among the standby path of the business computer 2 selected in step SP50 (SP52).

Next, the communication information data analysis processor 42 refers to the communication information database 46 and predicts the load on each network node when the communication path is to be switched to the standby path selected in step SP52 (SP53). Specifically speaking, the communication information data analysis processor 42 predicts the load on each network node as the total traffic of the relevant network node when the communication path is to be switched to the standby path selected in step SP52.

For example, in case the “standby path” is selected as the communication path of “Computer 2” in the above-described example, the total traffic of “Switching Hub 1” when the communication path of “Computer 2” is to be switched to the “standby path” is predicted as “700 M” by subtracting “200 M,” which is the traffic of “Computer 2,” from the current total traffic “900 M”; the total traffic of “Switching Hub 2” is predicted as “600 M” by adding “200 M,” which is the traffic of “Computer 2,” to the current total traffic “400 M”; and the total traffic of “Switching Hub 3” is predicted as “0 M” which is the same as the current total traffic. Furthermore, the total traffic of “Edge Router 1” is predicted as “700 M” by subtracting “200 M,” which is the traffic of “Computer 2,” from the current total traffic “900 M”; and the total traffic of “Edge Router 2” is predicted as “600 M” by adding “200 M,” which is the traffic of “Computer 2,” to the current total traffic “400 M.”

Subsequently, the communication information data analysis processor 42 judges whether or not each network node load (total traffic) predicted in step SP53 is equal to or less than a predetermined threshold with respect to each network node (SP55). Incidentally, this threshold is a value that can be freely set by the system administrator; and as an example, a value equal to or less than 80% of the allowable traffic of the relevant network node can be applied.

Then, in case the communication information data analysis processor 42 obtains a negative result in this judgment, it proceeds to step SP57. On the other hand, in case the communication information data analysis processor 42 obtains an affirmative result in the judgment of step SP54, it judges whether or not the then-calculated network node load is lower than a network node load of a standby path which is then set as a switch candidate (SP55).

Incidentally, the “switch candidate standby path” means a standby path whose network node load is judged to be lowest by the processing which has been executed as described later. Furthermore, comparison between the standby path to determine which standby path has a higher or lower network node load can be conducted by, for example, comparing the rate of the predicted value of the total traffic, which was calculated in step SP53, to the allowable traffic (hereinafter referred as the “predicted total traffic rate”) with respect to the network node having the highest rate for each of the standby path; in case the predicted total traffic rate of the then-targeted standby path is lower than the predicted total traffic rate of the switch candidate standby path, it is possible to determine that the load on the then-targeted standby path is lower than the load on the switch candidate standby path.

For example, in case the highest value of the predicted total traffic rate regarding the then-targeted standby path is 80% and the highest value of the predicted total traffic rate regarding the switch candidate standby path is 70%, it is determined that the load on the switch candidate standby path is lower than the load on the then-targeted standby path. On the other hand, for example, in case the highest value of the predicted total traffic rate regarding the then-targeted standby path is 75% and the highest value of the predicted total traffic rate regarding the switch candidate standby path is 80%, it is determined that the load on the then-targeted standby path is lower than the load on the switch candidate standby path.

Then, in case the communication information data analysis processor 42 obtains a negative result in the judgment of step SP55, it proceeds to step SP57. On the other hand, in case the communication information data analysis processor 42 obtains an affirmative result in the judgment of step SP55, it sets the then-targeted standby path of the then-targeted business computer 2 as a switch candidate (SP56).

Subsequently, the communication information data analysis processor 42 judges whether the execution of the processing from step SP52 to step SP56 on all the standby path of the then-targeted business computer 2 has been completed or not (SP57).

If the communication information data analysis processor 42 obtains a negative result in this judgment, it returns to step SP52 and then repeats the processing from step SP52 to step SP57 while switching the standby path selected in step SP52 to another unprocessed standby path.

Then, in case the communication information data analysis processor 42 obtains an affirmative result in step SP57 by eventually finishing executing the processing from step SP52 to step SP56 on all the standby path of the business computer selected in step SP50, it judges whether the execution of the processing from step SP50 to step SP57 on all the business computers 2 in the system has been completed or not (SP58).

If the communication information data analysis processor 42 obtains a negative result in this judgment, it returns to step SP50 and then repeats the processing from step SP50 to step SP58 while switching the business computer 2 selected in step SP50 to another unprocessed business computer 2.

Then, in case the communication information data analysis processor 42 obtains an affirmative result in step SP58 by eventually finishing executing the processing on all the business computers 2 in the system, it reports the standby path, which is set as the then switch candidate, and the business computer 2, which has that standby path, to the path switching request transmitter (SP59). As a result, as described earlier with respect to step SP15 in FIG. 8, the path switching request transmitter 43 transmits a path switching request to that business computer 2 to switch the communication path to that standby path. Then, the communication information data analysis processor 42 terminates this path switching computer selection processing.

(4) Advantageous Effects of this Embodiment

Regarding the network system 1 according to this embodiment described above, each business computer 2 acquires the path information concerning the active path and the standby path and the traffic per unit time of the active path and transmits these acquired pieces of information as the communication path information to the supervisory computer 8; and the supervisory computer 8 searches for a network node with a heavy-load based on the communication path information transmitted from each business computer 2; and when the supervisory computer 8 detects the network node with the heavy-load as a result of the search, it predicts each network node load when switching the communication path to a standby path with respect to each business computer 2, selects a standby path, regarding which each network node load is lowest, as a switch target standby path, and transmits a path switching request to the business computer 2 having the relevant standby path to switch the communication path from the active path to that standby path.

Therefore, with this network system 1, the communication path will not be switched to a heavy-load standby path and the load on the heavy-load network node can be distributed appropriately. Furthermore, this network system 1 enables such load distribution without requiring intervention of the system administrator. Therefore, this network system 1 makes it possible to dynamically provide the optimum load-distributed network environment without requiring trouble of the system administrator.

### (5) Other Embodiments

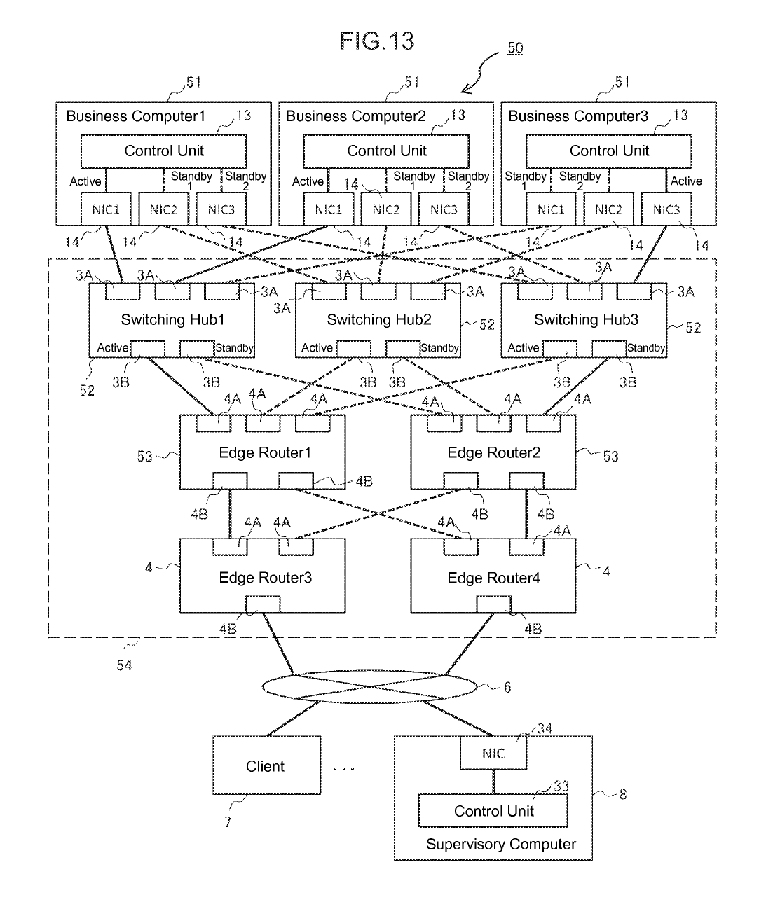

Incidentally, the aforementioned embodiment has described the case where the present invention is applied to the network system 1 configured as illustrated in FIG. 1; however, the present invention is not limited to this example and, for example, the present invention can be also applied to: a network system 50 as illustrated in FIG. 13, where the same reference numerals as those used in FIG. 1 are assigned to parts corresponding to FIG. 1 and the network system 50 has a plurality of standby path as a business computer 51 includes three or more communication devices 14 which are connected to different switching hubs 52, respectively; or the network system 50 in which an internal network 54 is configured by three or more stages of network nodes such as the switching hubs 52 and the edge routers 4, 53. Furthermore, the present invention can be applied to a wider variety of other network systems having configurations other than those described above.

Furthermore, the aforementioned embodiment has described the case where the comparison between the standby path in step SP55 of FIG. 12 to determine which standby path has a higher or lower network node load is conducted by comparing the highest value of the predicted total traffic rate; however, the present invention is not limited to this example and a wide variety of other methods can be applied. For example, the comparison between the standby path to determine which standby path has a higher or lower network node load the standby path may be conducted by comparing an average value of the predicted total traffic rate of each network node along the relevant standby path.

Furthermore, the aforementioned embodiment has described the case where the destination of the monitored packet transmitted from the business computer 2 is set as the supervisory computer 8; however, the present invention is not limited to this example and, in short, any node other than the supervisory computer 8 may be the destination of the monitored packet as long as a computer connected to the external network 6 is set as the destination of the monitored packet.

Furthermore, the aforementioned embodiment has described the case where each business computer 2 and the supervisory computer 8 regularly execute the processing in FIG. 8; however, the present invention is not limited to this example and, for example, the processing in FIG. 8 may be executed irregularly in accordance with the system administrator's command. However, as each business computer 2 and the supervisory computer 8 regularly execute the processing in FIG. 8 as in this embodiment, the load distribution by the network load distribution method according to this embodiment can be performed completely without requiring intervention of the system administrator.

### INDUSTRIAL APPLICABILITY

The present invention can be applied to a wide variety of network systems including computers with redundant communication paths.

### REFERENCE SIGNS LIST

1, 50 Network system; 2, 51 business computer; 3, 52 switching hub; 4, 53 edge router; 5, 54 internal network; 6 external network; 7 client; 8 supervisory computer; 10, 30 CPU; 11, 31 memory; 12, 32 storage; 13, 33 control unit; 14, 34 communication device; 21, 40 transmit/receive processor; 22 monitored packet processor; 23 communication information transmitter; 24 path switching request receiver; 25, 45 communication information management database; 41 communication information receiver; 42 communication information data analysis processor; 43 path switching request transmitter; 46 communication information database; and 47 statistic information.

1. A load distribution method for distributing loads on a plurality of network nodes in a network system including a network composed of the plurality of network nodes, a plurality of first computers for transmitting and receiving data via the network, and a second computer connected to the first computers via the network,
wherein the first computers include an active communication device for performing communications via the network and at least one standby communication device and the active communication device and the standby communication device are connected to another network node, respectively, in the network,
wherein the network system load distribution method comprising:
a first step, executed by the first computer, of acquiring path information concerning an active communication path and a standby communication path in the network and traffic of the active communication path;
a second step, executed by the first computer, of transmitting the acquired path information concerning the active communication path and the standby communication path and the traffic of the active communication path, respectively, to the second computer;
a third step, executed by the second computer, of searching for a network node with a heavy load among the respective network nodes constituting the network based on the path information concerning the active communication path and the standby communication path and the traffic of the active communication path which are transmitted from the first computer; and
a fourth step executed, upon detecting the network node with the heavy-load, by the second computer: predicting a load on each of the network nodes when the communication path of each first computer is to be switched to its individual standby communication path; selecting the first computer, whose communication path should be switched from the active communication path to the standby communication path, based on a result of the prediction and the standby communication path which should be a switching target of the communication path for the first computer; and requesting the selected first computer to switch the communication path from the active communication path to the selected standby communication path.

2. The network system load distribution method according to claim 1,
wherein in the first step, the first computer acquires the path information concerning each of the active communication path and the standby communication path in the network by transmitting a monitored packet to each of the active communication device and the standby communication device.

3. The network system load distribution method according to claim 1,
wherein in the fourth step, the second computer predicts the load on each network node, when the communication path of the first computer is to be switched to the standby path, as total traffic of the network node when the communication path is to be switched to the standby communication path.

4. The network system load distribution method according to claim 3,
wherein in the fourth step, the second computer: selects the standby communication path, regarding which the load on the network load becomes lowest when the communication path is switched, as the standby communication path which should be the switching target of the communication path; and selects the first computer including that standby communication path as the first computer whose communication path should be switched.

5. The network system load distribution method according to claim 4,
wherein in the fourth step, the second computer: calculates a rate of a predicted value of the total traffic to an allowable traffic at each network node in the standby communication path with respect to the standby communication path of each first computer; compares a highest value of the rate with respect to each standby communication path; selects the standby communication path, regarding which the highest value of the rate is lowest, as the standby communication path which should be the switching target of the communication path.

6. The network system load distribution method according to claim 1,
wherein the processing of the first and fourth steps is executed regularly.

7. A network system comprising:
a network composed of a plurality of network nodes;
a plurality of first computers for transmitting and receiving data via the network; and a second computer connected to the first computers via the network;
wherein the first computers includes an active communication device for performing communications via the network and at least one standby communication device and the active communication device and the standby communication device are connected to different network nodes, respectively, in the network;
wherein the first computer:
acquires path information concerning an active communication path and a standby communication path in the network and traffic of the active communication path; and
transmits the acquired path information concerning the active communication path and the standby communication path and the traffic of the active communication path, respectively, to the second computer; and
wherein the second computer searches for a network node with a heavy load among the respective network nodes constituting the network based on the path information concerning the active communication path and the standby communication path and the traffic of the active communication path which are transmitted from the first computer; and
upon detecting the network node with the heavy-load, the second computer: predicts a load on each of the network nodes when the communication path of each first computer is to be switched to its individual standby communication path; selects the first computer, whose communication path should be switched from the active communication path to the standby communication path, based on a result of the prediction and the standby communication path which should be a switching target of the communication path for the first computer; and requests the selected first computer to switch the communication path from the active communication path to the selected standby communication path.
